(19) United States
(12) Patent Application Publication
(10) Pub. No.: US 2002/0009392 A1
(43) Pub. Date: Jan. 24, 2002

(54) Methods of reducing fluid carryover in microfluidic devices

(76) Inventors: Jeffrey A. Wolk, Half Moon Bay, CA (US); J. Wallace Parce, Palo Alto, CA (US); Robert Nagle, Mountain View, CA (US); Colin B. Kennedy, Greenbrae, CA (US); Syed Husain, Fremont, CA (US); Advit Bhatt, Union City, CA (US); Garrett Unno, San Jose, CA (US)

Correspondence Address: LAW OFFICES OF JONATHAN ALAN QUINE, P O BOX 458, ALAMEDA, CA, 94501

(21) Appl. No.: 09/818,266

(22) Filed: Mar. 26, 2001

Related U.S. Application Data
(60) Provisional application No. 60/192,786, filed on Mar. 28, 2000.
(60) Provisional application No. 60/227,611, filed on Aug. 23, 2000.

(51) Int. Cl. B01L 3/02; G01N 1/14

(52) U.S. Cl. 422/63; 436/180; 422/67; 422/100; 422/104; 204/453; 204/604

(57) ABSTRACT

Methods for reducing fluid carryover by microfluidic devices including capillary element and/or fluid motion. Capillary elements coated with hydrophobic or hydrophilic coatings to resist fluid carryover are also provided. Microfluidic device handling systems are additionally included.

### CROSS REFERENCES TO RELATED APPLICATIONS

Pursuant to 35 U.S.C. §§ 119 and/or 120, and any other applicable statute or rule, this application claims the benefit of and priority to U.S. Ser. No. 60/192,786, filed on Mar. 28, 2000 and U.S. Ser. No. 60/227,611, filed on Aug. 23, 2000, the disclosures of which are incorporated by reference.

### BACKGROUND OF THE INVENTION

Certain microfluidic devices include capillary or pipettor elements extending from body structures of the devices. Typically, a capillary element, which includes a capillary channel disposed therethrough, fluidly communicates with a channel network or other cavity housed within the body structure and is optionally used to load reagents, samples, or other materials from external sources, such as microwell plates, into a specific analysis channel or other cavity. During operation, a microfluidic device pipettor element is often sequentially dipped into multiple buffers, reagents, samples, and other solutions. One problem associated with this approach is cross-contamination among solutions. The source of this type of contamination is typically a drop of solution that adheres both to the bottom tip of the capillary element and to a portion of the exterior surface of the element when the element is withdrawn from the particular solution and dipped into a different solution.

The throughput limiting consequences of fluid carryover contamination include the carried-over drop of sample or reagent not being completely dispersed in a buffer solution between insertion and reinsertion of the capillary or pipettor element into the buffer solution. This frequently leads to a non-trivial fraction of the non-dispersed sample or reagent solution being drawn into the capillary channel of the element upon reinsertion into the buffer solution which ultimately biases results upon sample detection. The fluid drop at the external tip of a capillary element can also negatively impact a microfluidic assay when undesired amounts of a reagent or other component are spontaneously injected into a device channel due to surface tension on the drop.

Accordingly, it would be advantageous to provide techniques that diminish fluid carryover. The present invention includes methods and devices that accomplish this objective.

### SUMMARY OF THE INVENTION

The present invention relates to various methods of sampling fluid materials which reduce fluid carryover, e.g., between sampling steps during certain microfluidic applications. These methods generally include moving capillary elements and/or fluid materials relative to one another. The methods also optionally include coating capillary elements to reduce fluid carryover. The invention additionally includes a microfluidic handler, e.g., for performing these methods.

The methods of sampling fluid material with a capillary element include dipping the capillary element into a first fluid material (e.g., a sample, a reagent, or the like). Thereafter, the capillary element is dipped into a second fluid material and, the second fluid material is moved relative to the capillary element, or the capillary element is moved relative to the second fluid material. The second fluid material typically includes a solution, such as a wash solution, a rinse solution, a buffer solution, a reagent solution, a sample solution, a spacer solution, a hydrophobic solution, a hydrophilic solution, or the like. Optionally, the moving step includes moving both the capillary element and the second fluid material simultaneously relative to one another. The methods also optionally include moving the first fluid material relative to the capillary element, moving the capillary element relative to the first fluid material, or moving both the capillary element and the first fluid material simultaneously relative to one another between the dipping steps. The methods also optionally include dipping the capillary element into a third fluid material, in which the moving step dissipates a drop of the first fluid material adhering to a portion of the capillary element into the second fluid material to reduce fluid carryover from the first dipping step to the third dipping step.

The invention includes various modes of moving fluid materials and capillary elements relative to one another. For example, the methods include moving the second fluid material or the capillary element in a lateral motion, a side-to-side motion, a circular motion, a semi-circular motion, a helical motion, an arched motion, an up-and-down motion, and/or another motion. The second fluid material is also optionally moved in a fluid stream or in a fluid recirculation/replenishing bath or trough.

The methods also include providing a capillary channel (e.g., a microchannel) through the capillary element. Additionally, the capillary element typically extends from a microfluidic device and fluidly communicates with a channel network disposed in the microfluidic device. Optionally, the first dipping step also includes drawing a portion of the first fluid material into the capillary element. Similarly, the second dipping step optionally includes drawing a portion of the second fluid material into the capillary element. When a portion of the second fluid material is drawn into the capillary element, the moving step dissipates carried-over first fluid material in the second fluid material to reduce an amount of the carried-over first fluid material drawn into the capillary element.

The methods optionally include dipping the capillary element into a third fluid material, in which the third fluid material is identical to or different from the first fluid material. Thereafter, the capillary element is optionally dipped into a fourth fluid material that is identical to or different from the second fluid material. Optionally, the fourth fluid material is moved relative to the capillary element or the capillary element is moved relative to the fourth fluid material. This second moving step also optionally includes moving both the capillary element and the fourth fluid material simultaneously relative to one another. An additional option includes repeating the third and fourth dipping steps and the second moving step at least once, in which fluid materials of repeated dipping steps are identical to or different from the third and fourth fluid materials. Optionally, the third dipping step also includes drawing a portion of the third fluid material into the capillary element. Similarly, the fourth dipping step optionally includes drawing a portion of the fourth fluid material into the capillary element. When a portion of the fourth fluid material is drawn into the capillary element (e.g., in embodiments where the second and fourth fluid materials are identical), the second moving step dissipates carried-over fluid material in the fourth fluid material to reduce an amount of the carried-over fluid material drawn into the capillary element.

The methods of sampling a fluid material with a capillary element also optionally include providing a coating on the capillary element in which the coating, e.g., reduces fluid carryover. An interior surface portion, an exterior surface portion, a rim portion, or a combination thereof of the capillary element are optionally coated with the coating. The coating is generally a hydrophobic coating or a hydrophilic coating. The methods also optionally include providing the coating to include a hydrophobic coating and the second fluid material to include a hydrophilic solution. Alternatively, the methods include providing the coating to include a hydrophilic coating and the second fluid material to include a hydrophobic solution.

The present invention also relates to a microfluidic device handler that includes a holder configured to receive the microfluidic device, a container sampling region proximal to the holder, and a controller operably connected to one or more handler components. During operation of the handler, the controller directs dipping of a portion of the microfluidic device into a portion of a container (e.g., a fluid recirculation/replenishing bath or trough, a microwell plate, or the like) in the container sampling region. For example, when the container comprises a fluid recirculation/replenishing bath or trough, the microfluidic device handler typically also includes a recirculation/replenishing pump operably connected to the fluid recirculation/replenishing bath or trough. The container portion includes a fluid material, in which the controller directs movement of the fluid material relative to the microfluidic device, or lateral movement of the microfluidic device in the fluid material while the microfluidic device portion is dipped into the fluid material.

The microfluidic device includes a capillary element that typically includes a capillary channel (e.g., a microchannel) disposed therethrough. The capillary element is the portion of the microfluidic device that is dipped into the fluid material. Optionally, the capillary element includes a hydrophobic or a hydrophilic coating disposed on an interior surface portion, an exterior surface portion, a rim portion, or a combination thereof.

The microfluidic device handler optionally includes a computer or a computer readable medium operably connected to the controller. The computer or the computer readable medium generally includes a computer program that includes, e.g., an instruction set for varying or selecting a rate or a mode of dipping the capillary element into the fluid material. For example, the mode of dipping the capillary element optionally includes one or more movements relative to the fluid material, such as a lateral motion, a side-to-side motion, a circular motion, a semi-circular motion, a helical motion, an arched motion, an up-and-down motion, and/or the like. The computer program also typically includes other instruction sets, such as an instruction set for varying or selecting a rate or a mode with which the fluid material moves relative to the microfluidic device. The mode with which the fluid material moves optionally includes, e.g., a fluid stream, a lateral motion, a side-to-side motion, a circular motion, a semi-circular motion, a helical motion, an arched motion, or the like.

### BRIEF DESCRIPTION OF THE DRAWING

FIG. 1A schematically depicts a microfluidic device and a microwell plate.

FIG. 1B schematically shows a drop of fluid adhering to the tip of a coated capillary element.

FIG. 1C schematically shows a drop of fluid adhering to the tip and a portion of the exterior surface of an uncoated capillary element.

FIG. 2 is a data graph that illustrates tailing as a function of capillary element motion.

FIG. 3 is a data graph that shows the results of a comparison of 7-amino-4-methylcoumarin (AMC) dye peaks in cathepsin K buffer with and without buffer flowing in a trough.

FIG. 4 schematically depicts one embodiment of a container sampling region that includes a fluid trough.

FIG. 5 schematically illustrates a peristaltic pump for use with the fluid trough shown in FIG. 4.

FIGS. 6A-6C schematically show a microfluidic device that includes a capillary element from various viewpoints.

FIG. 7 schematically illustrates a system that includes the microfluidic device of FIGS. 6A-6C.

### DETAILED DISCUSSION OF THE INVENTION

Introduction

The present invention generally provides improved methods, and related devices, for reducing fluid carryover by certain microfluidic devices. These microfluidic devices include at least one capillary or pipettor element (e.g., 1, 2, 3, 4, 6, 8, 10, 12 or more elements) extending from a device body structure. As used herein, a “capillary element” or a “pipettor element” includes an elongated body structure having a channel (e.g., a microchannel) disposed therethrough. A capillary element is alternatively a separate component that is temporarily coupled to multiple microfluidic device body structures or an integral extension of the body structure of a single microfluidic device.

Capillary elements are typically used to introduce samples, reagents, and other assay components into channels or other cavities housed within the body structure. This process generally involves multiple dipping steps in which a capillary or pipettor element is placed into various solutions. A drop of fluid typically clings to the tip region of a capillary element between dipping steps which leads to fluid being carried over, e.g., from one reagent well to another. The drop typically forms when attractive forces among component fluid molecules (i.e., cohesion) are less than attractive forces between component fluid molecules and component capillary element molecules (i.e., adhesion). As discussed above, fluid carryover is a problem that generally limits microfluidic device throughput.

The process of sampling multiple reagents or other solutions typically includes dipping capillary elements into buffer solutions between reagent sampling steps. During these intervening steps, a quantity of buffer solution is frequently drawn into the device, e.g., to function as a “spacer” between different reagent or sample portions. In this process, a drop of, e.g., the sample or reagent solution is typically carried over from the preceding dipping step into the intervening buffer solution. A significant problem related to this carried-over drop is that, in the absence of buffer and/or capillary element movement, carried-over drops are not completely dispersed in the buffer solution upon reinsertion of the capillary element back into the buffer solution following a subsequent sampling step. This frequently results in a non-trivial fraction of the incompletely dispersed carried-over drop(s) of previously sampled fluid(s) being drawn into spacer portions of buffer which causes biasing of results obtained in the system (e.g., the appearance of peak “shoulders” and other signal artifacts from carried-over materials). To reduce this and other fluid carryover-related problems, the present invention includes reducing fluid carryover, e.g., by rinsing or washing capillary or pipettor elements to dissipate fluid carryover between sampling steps (e.g., either the fluids are moved, or the capillary element is moved in the fluids, or both). Alternatively, capillary elements are coated to make them resistant to fluid carryover. Optionally, both of these approaches are utilized in conjunction.

Fluid Sampling Methods

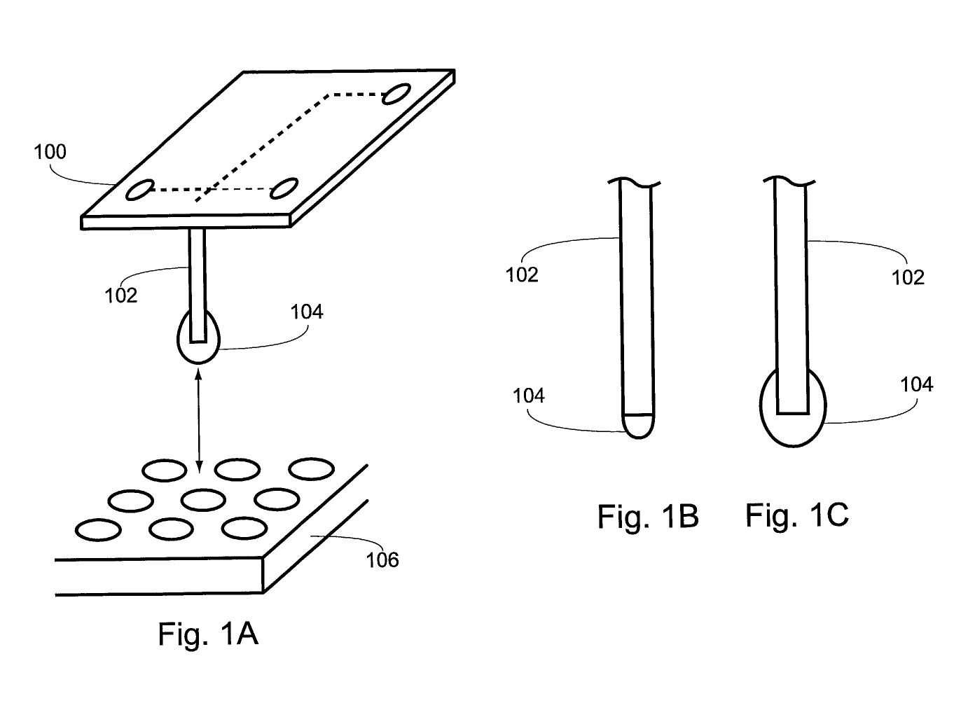

The present invention relates to various methods of sampling fluid materials using microfluidic device capillary elements to reduce fluid carryover. As depicted in FIG. 1A, capillary element 102 fluidly communicates with a microchannel network disposed within body structure 100. Although not shown, microfluidic devices optionally include more than one capillary or pipettor element (e.g., 2, 3, 4, 5, 6, 7, 8, 10, 11, 12 or more elements). During operation, capillary element 102 is typically sequentially dipped into multiple buffers, reagents, samples, and other solutions contained in the wells of microwell plate 106. As mentioned, one problem related to this approach is cross-contamination among solutions. This type of contamination is typically caused by drop 104 that adheres both to the bottom tip of capillary element 102 and to a portion of the exterior surface of capillary element 102 when capillary element 102 is withdrawn from the particular solution and dipped into a different solution. The consequences of fluid carryover include biased results upon assay detection, such as reagent tailing.

The fluid carryover reducing methods of the present invention include sampling fluid material by dipping capillary element 102 into a first fluid material (e.g., a sample, a reagent, etc.). Thereafter, capillary element 102 is dipped into a second fluid material and either, the second fluid material is moved relative to capillary element 102, or capillary element 102 is moved relative to the second fluid material. In one preferred embodiment, capillary element 102 is dipped into a fluid material and “wiggled” relative to the fluid material. Optionally, the moving step includes moving both capillary element 102 and the second fluid material simultaneously relative to one another. The second fluid material typically includes a solution, such as a wash solution, a rinse solution, a buffer solution, a reagent solution, a sample solution, a spacer solution, a hydrophobic solution, a hydrophilic solution, or the like. The methods optionally include moving the first fluid material relative to the capillary element, moving the capillary element relative to the first fluid material, or moving both the capillary element and the first fluid material simultaneously relative to one another between the dipping steps, e.g., to further minimize the occurrence of biased results, to reduce cycling time during fluid sampling, or the like. The methods also optionally include dipping capillary element 102 into a third fluid material, in which the moving step dissipates drop 104 of the first fluid material adhering to a portion of capillary element 102 into the second fluid material to reduce fluid carryover from the first dipping step to the third dipping step. During any dipping step, fluids are optionally drawn into capillary element 102.

The invention optionally includes various modes of moving fluid materials and capillary or pipettor elements relative to one another. For example, the methods include moving the second fluid material or capillary element 102 in a lateral motion, a side-to-side motion, a circular motion, a semi-circular motion, a helical motion, an arched motion, an up-and-down motion, and/or the like. The second fluid material is also optionally moved in a fluid stream or in a fluid recirculation/replenishing bath or trough. Examples 1 and 2, discussed further below, demonstrate the effectiveness of moving capillary elements or fluids relative to one another in reducing fluid carryover. As also described in greater detail below, the relative motions of fluid materials and capillary elements are optionally under the control of a microfluidic device handler.

As mentioned above, the capillary elements that extend from microfluidic device body structures are typically dipped into multiple solutions. Accordingly, the methods generally include dipping capillary element 102 into a third fluid material, in which the third fluid material is identical to or different from the first fluid material (e.g., a sample, a reagent, or the like). Thereafter, capillary element 102 is optionally dipped into a fourth fluid material that is identical to or different from the second fluid material. Optionally, the fourth fluid material is moved relative to capillary element 102 or capillary element 102 is moved relative to the fourth fluid material. This second moving step also optionally includes moving both capillary element 102 and the fourth fluid material simultaneously relative to one another. An additional option includes repeating the third and fourth dipping steps and the second moving step at least once, in which fluid materials of repeated dipping steps are identical to or different from the third and fourth fluid materials.

The methods of sampling fluids optionally include, e.g., disposing a recirculation/replenishing bath, trough, or other container proximal to a microwell plate, e.g., on a stage or in a container sampling region. During operation, microfluidic device capillary or pipettor elements are typically dipped into specific wells on the microwell plate in which reagents, samples, or other solutions are drawn from the wells into the device body structure, e.g., under pressure-based flow. Upon withdrawing the capillary elements from the wells, drops typically form near element tips as described above. Before preceding to sample other fluids from other wells on the same or a different microwell plate, the capillary elements are optionally dipped into the recirculation/replenishing trough in which the capillaries and/or a fluid (e.g., a buffer) in the trough are moved relative to one another to wash the carried-over drops from the capillary element tips. These methods, inter alia, reduce the problem of incompletely dispersed carried-over reagent or sample drops being included in spacer segments of buffer, as described above. In a preferred embodiment, the capillary elements are moved side-to-side at a selected rate of oscillation. Optionally, each sampling step can similarly be followed by an intervening wash or rinse step prior to preceding to the next sampling step. Fluid sampling is optionally fully automated, as described below, with respect to microfluidic device handling and integrated systems.

In alternative embodiments, a single microwell plate is optionally utilized for both fluid sampling and capillary element washing. To illustrate, capillary elements are initially dipped into specific sample or reagent containing wells on the plate and subsequently washed in, e.g., adjacent buffer-containing wells, before sampling other fluids. During the washing step, as described above, capillary elements and/or microwell plates are optionally moved relative to one another. For example, a controller optionally directs the movement of a stage on which the microwell plate is placed (e.g., in a side-to-side, circular, semi-circular, helical, arched, or other motion) while the capillary elements are dipped into the wash buffers. Similarly, while the capillary elements of the microfluidic devices are in the buffer wells, the elements of the devices are optionally moved relative to the wells of the plate.

Coated Capillary Elements

The methods of sampling a fluid material with a capillary or pipettor element also optionally include providing a coating on the element in which the coating reduces fluid carryover. An interior surface portion, an exterior surface portion, a rim portion, or a combination of those capillary element components are optionally coated with the coating. The coating is generally a hydrophobic coating or a hydrophilic coating. For example, a hydrophobic coating is typically used when the sample solution is substantially hydrophilic, whereas a hydrophilic coating is typically used when the sample solution is substantially hydrophobic.

The effect of coating a capillary element is depicted in FIGS. 1B and 1C. FIG. 1C is a magnified view of a portion of capillary element 102 (uncoated) with drop 104 of fluid (e.g., water) adhering both to the bottom tip of capillary element 102 and to a portion of the exterior surface of capillary element 102. FIG. 1B shows the effect of coating the exterior surface of capillary element 102 with a hydrophobic coating which acts to repel, in this example, water from the coated surface, such that drop 104 adheres to only the bottom tip of capillary element 102. Accordingly, the methods optionally include providing the coating to include a hydrophobic coating and the second fluid material to include a hydrophilic solution (e.g., water, electrolytes, or other polar solutions). Alternatively, the methods include providing the coating to include a hydrophilic coating and the second fluid material to include a hydrophobic solution (e.g., hydrocarbons, oils or other apolar solutions).

Many hydrophobic and hydrophilic coatings are known and are optionally used in the methods and devices of the present invention. For example, suitable hydrophobic coatings optionally include substances, such as hydrophobic polymers, fluorocarbon polymers, chlorinated polysiloxanes, polytetrafluoroethylenes (TEFLON™), polyglycines, polyalanines, polyvalines, polyleucines, polyisoleucines, chlorine terminated polydimethylsiloxane telomers, bis(perfluorododecyl) terminated poly(dimethylsiloxane-co-dimer acids), derivatives thereof, or the like. TEFLON™ coated capillary or pipettor elements are generally preferred and are readily available from various commercial sources (e.g., Polymicro Technologies, LLC or the like). Appropriate hydrophilic coatings optionally include substances, such as hydrophilic polymers, polyimides, polyethylene oxides, polyvinylpyrrolidone, polyacrylates, hydrophilic polysaccharides, hyaluronic acids, chondroitin sulfates, derivatives thereof, or the like.

As mentioned, coated capillary elements are optionally used in conjunction with the methods of sampling fluids to further reduce fluid carryover, e.g., between sampling steps. For example, after withdrawing capillary elements from sample wells on a microwell plate, the adhering drops will typically be smaller on coated element tips, than on uncoated tips. This size difference is depicted in FIGS. 1B and 1C. Thus, less fluid carryover is present for a subsequent washing step in, e.g., a recirculation/replenishing bath or trough.

It should be noted that fluid carryover is also optionally reduced by varying other parameters of the capillary elements. For example, the inner diameter, e.g., at the external tip of a capillary element, generally affects carryover, with smaller diameters typically resulting in less carryover than larger diameters. Other options include varying the shape of a capillary element, such as cross-sectional shapes of interior and/or exterior portions of the element to form, e.g., regular n-sided polygons, irregular n-sided polygons, triangles, squares, rectangles, trapezoids, ovals, or the like. Many of these capillary element shapes are commercially available from various suppliers including, e.g., Polymicro Technologies, LLC or the like. These variations are optionally used alone or in conjunction with any of the methods or devices disclosed herein.

Microfluidic Devices

Many different microscale systems are optionally adapted for use in the present invention by, e.g., incorporating various microfluidic device capillary or pipettor element movements, certain fluid movements (e.g., in circulation troughs or baths), and/or various element coatings, as discussed below. These systems are described in various PCT applications and issued U.S. Patents by the inventors and their coworkers, including U.S. Pat. Nos. 5,699,157 (J. Wallace Parce) issued Dec. 16, 1997, 5,779,868 (J. Wallace Parce et al.) issued Jul. 14, 1998, 5,800,690 (Calvin Y. H. Chow et al.) issued Sep. 01, 1998, 5,842,787 (Anne R. Kopf-Sill et al.) issued Dec. 01, 1998, 5,852,495 (J. Wallace Parce) issued Dec. 22, 1998, 5,869,004 (J. Wallace Parce et al.) issued Feb. 09, 1999, 5,876,675 (Colin B. Kennedy) issued Mar. 02, 1999, 5,880,071 (J. Wallace Parce et al.) issued Mar. 09, 1999, 5,882,465 (Richard J. McReynolds) issued Mar. 16, 1999, 5,885,470 (J. Wallace Parce et al.) issued Mar. 23, 1999, 5,942,443 (J. Wallace Parce et al.) issued Aug. 24, 1999, 5,948,227 (Robert S. Dubrow) issued Sep. 07, 1999, 5,955,028 (Calvin Y. H. Chow) issued Sep. 21, 1999, 5,957,579 (Anne R. Kopf-Sill et al.) issued Sep. 28, 1999, 5,958,203 (J. Wallace Parce et al.) issued Sep. 28, 1999, 5,958,694 (Theo T. Nikiforov) issued Sep. 28, 1999, 5,959,291 (Morten J. Jensen) issued Sep. 28, 1999, 5,964,995 (Theo T. Nikiforov et al.) issued Oct. 12, 1999, 5,965,001 (Calvin Y. H. Chow et al.) issued Oct. 12, 1999, 5,965,410 (Calvin Y. H. Chow et al.) issued Oct. 12, 1999, 5,972,187 (J. Wallace Parce et al.) issued Oct. 26, 1999, 5,976,336 (Robert S. Dubrow et al.) issued Nov. 2, 1999, 5,989,402 (Calvin Y. H. Chow et al.) issued Nov. 23, 1999, 6,001,231 (Anne R. Kopf-Sill) issued Dec. 14, 1999, 6,011,252 (Morten J. Jensen) issued Jan. 4, 2000, 6,012,902 (J. Wallace Parce) issued Jan. 11, 2000, 6,042,709 (J. Wallace Parce et al.) issued Mar. 28, 2000, 6,042,710 (Robert S. Dubrow) issued Mar. 28, 2000, 6,046,056 (J. Wallace Parce et al.) issued Apr. 4, 2000, 6,048,498 (Colin B. Kennedy) issued Apr. 11, 2000, 6,068,752 (Robert S. Dubrow et al.) issued May 30, 2000, 6,071,478 (Calvin Y. H. Chow) issued Jun. 6, 2000, 6,074,725 (Colin B. Kennedy) issued Jun. 13, 2000, 6,080,295 (J. Wallace Parce et al.) issued Jun. 27, 2000, 6,086,740 (Colin B. Kennedy) issued Jul. 11, 2000, 6,086,825 (Steven A. Sundberg et al.) issued Jul. 11, 2000, 6,090,251 (Steven A. Sundberg et al.) issued Jul. 18, 2000, 6,100,541 (Robert Nagle et al.) issued Aug. 8, 2000, 6,107,044 (Theo T. Nikiforov) issued Aug. 22, 2000, 6,123,798 (Khushroo Gandhi et al.) issued Sep. 26, 2000, 6,129,826 (Theo T. Nikiforov et al.) issued Oct. 10, 2000, 6,132,685 (Joseph E. Kersco et al.) issued Oct. 17, 2000, 6,148,508 (Jeffrey A. Wolk) issued Nov. 21, 2000, 6,149,787 (Andrea W. Chow et al.) issued Nov. 21, 2000, 6,149,870 (J. Wallace Parce et al.) issued Nov. 21, 2000, 6,150,119 (Anne R. Kopf-Sill et al.) issued Nov. 21, 2000, 6,150,180 (J. Wallace Parce et al.) issued Nov. 21, 2000, 6,153,073 (Robert S. Dubrow et al.) issued Nov. 28, 2000, 6,156,181 (J. Wallace Parce et al.) issued Dec. 5, 2000, 6,167,910 (Calvin Y. H. Chow) issued Jan. 2, 2001, 6,171,067 (J. Wallace Parce) issued Jan. 9, 2001, 6,171,850 (Robert Nagle et al.) issued Jan. 9, 2001, 6,172,353 (Morten J. Jensen) issued Jan. 9, 2001, 6,174,675 (Calvin Y. H. Chow et al.) issued Jan. 16, 2001, 6,182,733 (Richard J. McReynolds) issued Feb. 6, 2001, and 6,186,660 (Anne R. Kopf-Sill et al.) issued Feb. 13, 2001; and published PCT applications, such as, WO 98/00231, WO 98/00705, WO 98/00707, WO 98/02728, WO 98/05424, WO 98/22811, WO 98/45481, WO 98/45929, WO 98/46438, and WO 98/49548, WO 98/55852, WO 98/56505, WO 98/56956, WO 99/00649, WO 99/10735, WO 99/12016, WO 99/16162, WO 99/19056, WO 99/19516, WO 99/29497, WO 99/31495, WO 99/34205, WO 99/43432, WO 99/44217, WO 99/56954, WO 99/64836, WO 99/64840, WO 99/64848, WO 99/67639, WO 00/07026, WO 00/09753, WO 00/10015, WO 00/21666, WO 00/22424, WO 00/26657, WO 00/42212, WO 00/43766, WO 00/45172, WO 00/46594, WO 00/50172, WO 00/50642, WO 00/58719, WO 00/060108, WO 00/070080, WO 00/070353, WO 00/072016, WO 00/73799, WO 00/078454, WO 00/102850, and WO 00/114865.

The methods of the invention are generally performed within fluidic channels along which reagents, samples, buffers, and other fluids are disposed and/or flowed. In some cases, as mentioned above, the channels are simply present in a capillary or pipettor element, e.g., a glass, fused silica, quartz or plastic capillary. The capillary element is fluidly coupled to a source of, e.g., the reagent, sample, or other solution (e.g., by dipping the capillary element into a well on a microwell plate), which is then flowed along the channel (e.g., a microchannel) of the element. In preferred embodiments, the capillary element is integrated into the body structure of a microfluidic device. The term “microfluidic,” as used herein, generally refers to one or more fluid passages, chambers or conduits which have at least one internal cross-sectional dimension, e.g., depth, width, length, diameter, etc., that is less than 500 μm, and typically between about 0.1 μm and about 500 μm.

In the devices of the present invention, the microscale channels or cavities typically have at least one cross-sectional dimension between about 0.1 μm and 200 μm, preferably between about 0.1 μm and 100 μm, and often between about 0.1 μm and 50 μm. Accordingly, the microfluidic devices or systems prepared in accordance with the present invention typically include at least one microscale channel, usually at least two intersecting microscale channels, and often, three or more intersecting channels disposed within a single body structure. Channel intersections may exist in a number of formats, including cross intersections, “Y” and/or “T” intersections, or any number of other structures whereby two channels are in fluid communication.

The body structures of the microfluidic devices described herein are typically manufactured from two or more separate portions or substrates which when appropriately mated or joined together, form the microfluidic device of the invention, e.g., containing the channels and/or chambers described herein. During body structure fabrication, the microfluidic devices described herein will typically include a top portion, a bottom portion, and an interior portion, wherein the interior portion substantially defines the channels and chambers of the device.

In preferred aspects, the bottom portion of the unfinished device includes a solid substrate that is substantially planar in structure, and which has at least one substantially flat upper surface. Channels are typically fabricated on one surface of the device. A variety of substrate materials are optionally employed as the bottom portion. Typically, because the devices are microfabricated, substrate materials will be selected based upon their compatibility with known microfabrication techniques, e.g., photolithography, wet chemical etching, laser ablation, air abrasion techniques, LIGA, reactive ion etching, injection molding, embossing, and other techniques. The substrate materials are also generally selected for their compatibility with the full range of conditions to which the microfluidic devices may be exposed, including extremes of pH, temperature, electrolyte concentration, and application of electric fields. Accordingly, in some preferred aspects, the substrate material may include materials normally associated with the semiconductor industry in which such microfabrication techniques are regularly employed, including, e.g., silica-based substrates, such as glass, quartz, silicon or polysilicon, as well as other substrate materials, such as gallium arsenide and the like. In the case of semiconductive materials, it will often be desirable to provide an insulating coating or layer, e.g., silicon oxide, over the substrate material, and particularly in those applications where electric fields are to be applied to the device or its contents.

In additional preferred aspects, the substrate materials will comprise polymeric materials, e.g., plastics, such as polymethylmethacrylate (PMMA), polycarbonate, polytetrafluoroethylene (TEFLON™), polyvinylchloride (PVC), polydimethylsiloxane (PDMS), polysulfone, polystyrene, polymethylpentene, polypropylene, polyethylene, polyvinylidine fluoride, ABS (acrylonitrile-butadiene-styrene copolymer), and the like. Such polymeric substrates are readily manufactured using available microfabrication techniques, as described above, or from microfabricated masters, using known molding techniques, such as injection molding, embossing or stamping, or by polymerizing the polymeric precursor material within the mold (See, e.g., U.S. Pat. No. 5,512,131). Such polymeric substrate materials are preferred for their ease of manufacture, low cost and disposability, as well as their general inertness to most extreme reaction Gconditions. Again, these polymeric materials optionally include treated surfaces, e.g., derivatized or coated surfaces, to enhance their utility in the microfluidic system, e.g., to provide enhanced fluid direction, e.g., as described in U.S. Pat. No. 5,885,470 (J. Wallace Parce et al.) issued Mar. 23, 1999, and which is incorporated herein by reference in its entirety for all purposes.

The channels and/or cavities of the microfluidic devices are typically fabricated into the upper surface of the bottom substrate or portion of the device, as microscale grooves or indentations, using the above described microfabrication techniques. The top portion or substrate also comprises a first planar surface, and a second surface opposite the first planar surface. In the microfluidic devices prepared in accordance with certain aspects of the methods described herein, the top portion can include at least one aperture, hole or port disposed therethrough, e.g., from the first planar surface to the second surface opposite the first planar surface. In other embodiments, the port(s) are optionally omitted, e.g., where fluids are introduced solely through external capillary elements.

The first planar surface of the top portion or substrate is then mated, e.g., placed into contact with, and bonded to the planar surface of the bottom substrate, covering and sealing the grooves and/or indentations in the surface of the bottom substrate, to form the channels and/or chambers (i.e., the interior portion) of the device at the interface of these two components. Bonding of substrates is typically carried out by any of a number of different methods, e.g., thermal bonding, solvent bonding, ultrasonic welding, and the like. The finished body structure of a device is a unitary structure that houses, e.g., the channels and/or chambers of the device.

The hole(s) in the top of the finished device is/are oriented to fluidly communicate with at least one of the channels and/or cavities. In the completed device, the hole(s) optionally function as reservoirs for facilitating fluid or material introduction into the channels or chambers of the device, as well as providing ports at which electrodes or pressure elements are optionally placed into contact with fluids within the device, allowing application of electric fields or pressure gradients along the channels of the device to control and direct fluid transport within the device. In many embodiments, extensions are provided over these reservoirs to allow for increased fluid volumes, permitting longer running assays, and better controlling fluid flow parameters, e.g., hydrostatic pressures. Examples of methods and apparatuses for providing such extensions are described in U.S. Application No. 09/028,965, filed Feb. 24, 1998, and incorporated herein by reference. These devices are optionally coupled to a sample introduction port, e.g., a pipettor or capillary element, which serially introduces multiple samples, e.g., from the wells of a microtiter plate. Thus, in some embodiments, both reservoirs in the upper surface and external capillary elements are present in a single device.

The sources of reagents, samples, buffers, and other materials are optionally fluidly coupled to the microchannels in any of a variety of ways. In particular, those systems comprising sources of materials set forth in Knapp et al. “Closed Loop Biochemical Analyzers” (WO 98/45481; PCT/US98/06723) and U.S. Pat. No. 5,942,443 issued Aug. 24, 1999, entitled “High Throughput Screening Assay Systems in Microscale Fluidic Devices” to J. Wallace Parce et al. and, e.g., in 60/128,643 filed Apr. 4, 1999, entitled “Manipulation of Microparticles In Microfluidic Systems,” by Mehta et al. are applicable.

In these systems and as noted above, a capillary or pipettor element (i.e., an element in which components are optionally moved from a source to a microscale element such as a second channel or reservoir) is temporarily or permanently coupled to a source of material. The source is optionally internal or external to a microfluidic device that includes the pipettor or capillary element. Example sources include microwell plates, membranes or other solid substrates comprising lyophilized components, wells or reservoirs in the body of the microscale device itself and others.

As further illustrated in FIG. 1A, capillary element 102 is typically fluidly coupled with a port, such as a well on microwell plate 106, external to body structure 100. Alternatively, a loading element is coupled to an electropipettor channel with a port external to the body structure, a pressure-based pipettor element with a port external to the body structure, a pipettor element with a port internal to the body structure, an internal channel within the body structure fluidly coupled to a well on the surface of the body structure, an internal channel within the body structure fluidly coupled to a well within the body structure, or the like.

Flow of Reagents in Microfluidic Systems

The flowing of reagents or other materials along the microchannels of the devices described herein is optionally carried out by a number of mechanisms, including pressure-based flow, electrokinetic flow, hydrodynamic flow, gravity-based flow, centripetal or centrifugal flow, or mechanisms that utilize a hybrid of these techniques. In a preferred aspect, a pressure differential is used to flow the materials along, e.g., a capillary or other channel.

Application of a pressure differential along the channel is carried out by any of a number of approaches. For example, it may be desirable to provide relatively precise control of the flow rate of samples and/or other reagents, e.g., to precisely control incubation or separation times, etc. As such, in many preferred aspects, flow systems that are more active than hydrostatic pressure driven systems are employed. In certain cases, reagents may be flowed by applying a pressure differential across the length of the analysis channel. For example, a pressure source (positive or negative) is applied at the reagent reservoir at one end of the analysis channel, and the applied pressure forces the reagents through the channel. The pressure source is optionally pneumatic, e.g., a pressurized gas, or a positive displacement mechanism, i.e., a plunger fitted into a reagent reservoir, for forcing the reagents through the analysis channel. Alternatively, a vacuum source is applied to a reservoir at the opposite end of the channel to draw the reagents through the channel. Pressure or vacuum sources may be supplied external to the device or system, e.g., external vacuum or pressure pumps sealably fitted to the inlet or outlet of the analysis channel, or they may be internal to the device, e.g., microfabricated pumps integrated into the device and operably linked to the analysis channel. Examples of microfabricated pumps have been widely described in the art. See, e.g., published International Application No. WO 97/02357.

In an alternative simple passive aspect, the reagents are deposited in a reservoir or well at one end of an analysis channel and at a sufficient volume or depth, that the reagent sample creates a hydrostatic pressure differential along the length of the analysis channel, e.g., by virtue of it having greater depth than a reservoir at an opposite terminus of the channel. The hydrostatic pressure then causes the reagents to flow along the length of the channel. Typically, the reservoir volume is quite large in comparison to the volume or flow through rate of the channel, e.g., 10 μl reservoirs, vs. 1000 μm² channel cross-section. As such, over the time course of the assay, the flow rate of the reagents will remain substantially constant, as the volume of the reservoir, and thus, the hydrostatic pressure changes very slowly. Applied pressure is then readily varied to yield different reagent flow rates through the channel. In screening applications, varying the flow rate of the reagents is optionally used to vary the incubation time of the reagents. In particular, by slowing the flow rate along the channel, one can effectively lengthen the amount of time between introduction of reagents and detection of a particular effect. Alternatively, analysis channel lengths, detection points, or reagent introduction points are varied in fabrication of the devices, to vary incubation times.

In further alternate aspects, other flow systems are employed in transporting reagents through the analysis channel. One example of such alternate methods employs electrokinetic forces to transport the reagents. Electrokinetic transport systems typically utilize electric fields applied along the length of channels that have a surface potential or charge associated therewith. When fluid is introduced into the channel, the charged groups on the inner surface of the channel ionize, creating locally concentrated levels of ions near the fluid surface interface. Under an electric field, this charged sheath migrates toward the cathode or anode (depending upon whether the sheath comprises positive or negative ions) and pulls the encompassed fluid along with it, resulting in bulk fluid flow. This flow of fluid is generally termed electroosmotic flow. Where the fluid includes reagents, the reagents are also pulled along. A more detailed description of controlled electrokinetic material transport systems in microfluidic systems is described in published International Pat. Application No. WO 96/04547, which is incorporated herein by reference.

Hydrostatic, wicking and capillary forces are also optionally used to provide for fluid flow. See, e.g., “Method and Apparatus for Continuous Liquid Flow in Microscale Channels Using Pressure Injection, Wicking and Electrokinetic Injection,” by Alajoki et al., U.S. Ser. No. 09/245,627, filed Feb. 5, 1999. In these methods, an adsorbent material or branched capillary structure is placed in fluidic contact with a region where pressure is applied, thereby causing fluid to move towards the adsorbent material or branched capillary structure.

In alternative aspects, flow of reagents is driven by inertial forces. In particular, the analysis channel is optionally disposed in a substrate that has the conformation of a rotor, with the analysis channel extending radially outward from the center of the rotor. The reagents are deposited in a reservoir that is located at the interior portion of the rotor and is fluidly connected to the channel. During rotation of the rotor, the centripetal force on the reagents forces the reagents through the analysis channel, outward toward the edge of the rotor. Multiple analysis channels are optionally provided in the rotor to perform multiple different analyses. Detection of a detectable signal produced by the reagents is then carried out by placing a detector under the spinning rotor and detecting the signal as the analysis channel passes over the detector. Examples of rotor systems have been previously described for performing a number of different assay types. See, e.g., Published International Application No. WO 95/02189. Test compound reservoirs are optionally provided in the rotor, in fluid communication with the analysis channel, such that the rotation of the rotor also forces the test compounds into the analysis channel.

For purposes of illustration the discussion has focused on a single channel and accessing capillary, however, it will be readily appreciated that these aspects may be provided as multiple parallel analysis channels and accessing capillaries, in order to substantially increase the throughput of the system. Specifically, single body structures may be provided with multiple parallel analysis channels coupled to multiple sample accessing capillaries that are positioned to sample multiple samples at a time from sample libraries, e.g., multiwell plates. As such, these capillaries are generally spaced at regular distances that correspond with the spacing of wells in multiwell plates, e.g., 9 mm centers for 96 well plates, 4.5 mm for 384 well plates, and 2.25 mm for 1536 well plates.

Microfluidic Device Handlers and Other Integrated Systems

The present invention, in addition to other integrated system components, also provides a microfluidic device handler for performing the methods disclosed herein. Specifically, the microfluidic device handler includes a holder configured to receive the microfluidic device, a container sampling region proximal to the holder, and a controller operably connected to one or more handler components. During operation of the handler, the controller directs dipping of microfluidic device capillary or pipettor element(s) into a portion of a container (e.g., a fluid recirculation/replenishing bath or trough, a microwell plate, or the like) in the container sampling region. As described above, capillary elements optionally include hydrophobic or hydrophilic coatings disposed on an interior surface portion, an exterior surface portion, a rim portion, or a combination of those element components to further reduce fluid carryover between dipping steps. The container portion includes a fluid material (e.g., a sample, a reagent, a buffer, or other solution), in which the controller directs movement of the fluid material relative to the capillary element(s) of the microfluidic device, and/or lateral movement of the element(s) in the fluid material while the capillary element(s) is/are dipped into the fluid material.

As indicated, when the microfluidic device handler includes a fluid recirculation/replenishing bath or trough, the system also generally includes a recirculation/replenishing pump operably connected to the bath or trough. The recirculation/replenishing pump is typically operably connected to the fluid recirculation/replenishing bath or trough by an inlet tube and an outlet tube. Optionally, an inner diameter of the outlet tube is greater than an inner diameter of the inlet tube. This prevents fluid overflow at any rate of flow from the pump. Additionally, the recirculation/replenishing bath or trough optionally includes a plurality of compartments. Each of the plurality of compartments optionally fluidly communicates with at least one other compartment and a bottom portion of at least one of the plurality of compartments optionally includes a fluid inlet.

The microfluidic device handler also optionally includes a computer or a computer readable medium operably connected to the controller. The computer or the computer readable medium typically includes an instruction set for varying or selecting a rate or a mode of dipping capillary element(s) into fluid materials. For example, the mode of dipping the capillary element(s) optionally includes one or more movements relative to the fluid materials, such as a lateral motion, a side-to-side motion, a circular motion, a semi-circular motion, a helical motion, an arched motion, an up-and-down motion, and/or the like. The computer or the computer readable medium also optionally includes an instruction set for varying or selecting a rate or a mode with which the fluid material moves relative to the microfluidic device in, e.g., a recirculation/replenishing bath or trough. The mode with which the fluid material moves optionally includes, e.g., a fluid stream, a lateral motion, a side-to-side motion, a circular motion, a semi-circular motion, a helical motion, an arched motion, or the like.

Although the devices and systems specifically illustrated herein are generally described in terms of the performance of a few or one particular operation, it will be readily appreciated from this disclosure that the flexibility of these systems permits easy integration of additional operations into these devices. For example, the devices and systems described will optionally include structures, reagents and systems for performing virtually any number of operations in addition to the operations specifically described herein. Aside from fluid handling to reduce fluid carryover, other upstream or downstream operations include, e.g., particle separation, extraction, purification, amplification, cellular activation, labeling reactions, dilution, aliquotting, separation of sample components, labeling of components, assays and detection operations, electrokinetic or pressure-based injection of components into contact with particle sets, or materials released from particle sets, or the like.

Assay and detection operations include, without limitation, cell fluorescence assays, cell activity assays, probe interrogation assays, e.g., nucleic acid hybridization assays utilizing individual probes, free or tethered within the channels or chambers of the device and/or probe arrays having large numbers of different, discretely positioned probes, receptor/ligand assays, immunoassays, and the like. Any of these elements are optionally fixed to array members, or fixed, e.g., to channel walls, or the like.

In the present invention, the materials are optionally monitored and/or detected so that, e.g., an activity can be determined. The systems described herein generally include microfluidic device handlers, as described above, in conjunction with additional instrumentation for controlling fluid transport, flow rate and direction within the devices, detection instrumentation for detecting or sensing results of the operations performed by the system, processors, e.g., computers, for instructing the controlling instrumentation in accordance with preprogrammed instructions, receiving data from the detection instrumentation, and for analyzing, storing and interpreting the data, and providing the data and interpretations in a readily accessible reporting format.

Controllers

The controllers of the microfluidic device handling systems of the present invention direct dipping of capillary elements into, e.g., fluid recirculation/replenishing baths or troughs, microwell plates, or the like. Additionally, controllers optionally direct movement of fluid materials relative to microfluidic device capillary elements placed into the fluids and/or lateral movement of capillary elements relative to the fluid materials. The various modes of fluid and capillary movement are discussed above. A variety of controlling instrumentation is also optionally utilized in conjunction with the microfluidic devices and handling systems described herein, for controlling the transport, concentration, direction, and motion of fluids and/or materials within the devices of the present invention, e.g., by pressure-based or electrokinetic control.

As described above, in many cases, fluid transport, concentration, and direction are controlled in whole or in part, using pressure based flow systems that incorporate external or internal pressure sources to drive fluid flow. Internal sources include microfabricated pumps, e.g., diaphragm pumps, thermal pumps, and the like that have been described in the art. See, e.g., U.S. Pat. Nos. 5,271,724, 5,277,556, and 5,375,979 and Published PCT Application Nos. WO 94/05414 and WO 97102357. As also noted above, the systems described herein can also utilize electrokinetic material direction and transport systems. Preferably, external pressure sources are used, and applied to ports at channel termini. These applied pressures, or vacuums, generate pressure differentials across the lengths of channels to drive fluid flow through them. In the interconnected channel networks described herein, differential flow rates on volumes are optionally accomplished by applying different pressures or vacuums at multiple ports, or preferably, by applying a single vacuum at a common waste port and configuring the various channels with appropriate resistance to yield desired flow rates. Example systems are also described in U.S. Ser. No. 09/238,467, filed Jan. 28, 1999.

Typically, the controller systems are appropriately configured to receive or interface with a microfluidic device or system element as described herein. For example, the controller and/or detector, optionally includes a stage upon which the device of the invention is mounted to facilitate appropriate interfacing between the controller and/or detector and the device. Typically, the stage includes an appropriate mounting/alignment structural element, such as a nesting well, alignment pins and/or holes, asymmetric edge structures (to facilitate proper device alignment), and the like. Many such configurations are described in the references cited herein.

The controlling instrumentation discussed above is also used to provide for electrokinetic injection or withdrawal of material downstream of the region of interest to control an upstream flow rate. The same instrumentation and techniques described above are also utilized to inject a fluid into a downstream port to function as a flow control element.

Detector

The devices herein optionally include signal detectors, e.g., which detect concentration, fluorescence, phosphorescence, radioactivity, pH, charge, absorbance, refractive index, luminescence, temperature, magnetism, mass, or the like. The detector(s) optionally monitors one or a plurality of signals from upstream and/or downstream of an assay mixing point in which, e.g., a ligand and an enzyme are mixed. For example, the detector optionally monitors a plurality of optical signals which correspond in position to “real time” assay results.

Example detectors or sensors include photomultiplier tubes, CCD arrays, optical sensors, temperature sensors, pressure sensors, pH sensors, conductivity sensors, mass sensors, scanning detectors, or the like. Cells or other components which emit a detectable signal are optionally flowed past the detector, or, alternatively, the detector can move relative to the array to determine the position of an assay component (or, the detector can simultaneously monitor a number of spatial positions corresponding to channel regions, e.g., as in a CCD array). Each of these types of sensors is optionally readily incorporated into the microfluidic systems described herein. In these systems, such detectors are placed either within or adjacent to the microfluidic device or one or more channels, chambers or conduits of the device, such that the detector is within sensory communication with the device, channel, or chamber. The phrase “within sensory communication” of a particular region or element, as used herein, generally refers to the placement of the detector in a position such that the detector is capable of detecting the property of the microfluidic device, a portion of the microfluidic device, or the contents of a portion of the microfluidic device, for which that detector was intended. The detector optionally includes or is operably linked to a computer, e.g., which has software for converting detector signal information into assay result information (e.g., kinetic data of modulator activity), or the like. A microfluidic system optionally employs multiple different detection systems for monitoring the output of the system. Detection systems of the present invention are used to detect and monitor the materials in a particular channel region (or other reaction detection region).

The detector optionally exists as a separate unit, but is preferably integrated with the controller system, into a single instrument. Integration of these functions into a single unit facilitates connection of these instruments with the computer (described below), by permitting the use of few or a single communication port(s) for transmitting information between the controller, the detector and the computer.

Computer

As noted above, the microfluidic device handler of the present invention optionally includes a computer operably connected to the controller. The computer (or a computer readable medium) typically includes at least one computer program that includes one or more of the following:

1. an instruction set that directs the computer to vary or select a rate or a mode of dipping the capillary element into the fluid material (e.g., by controlling the relative motion of the capillary element and the fluid material);

2. an instruction set that directs the computer to vary or select a rate or a mode with which the fluid material moves relative to the microfluidic device;

3. an instruction set that directs the computer to move the microfluidic device to selected wells of one or more microwell plates disposed in the container sampling region (e.g., serially or variably relative to the wells of a particular microwell plate);

4. an instruction set that directs the computer to dip the microfluidic device into selected wells of one or more microwell plates disposed in the container sampling region (e.g., by controlling relative motion);

5. an instruction set that directs the computer to draw selected volumes from selected wells of one or more microwell plates disposed in the container sampling region;

6. an instruction set that directs the computer to move the microfluidic device to at least one recirculationlreplenishing bath or trough disposed in the container sampling region;

7. an instruction set that directs the computer to dip the microfluidic device into at least one recirculation/replenishing bath or trough disposed in the container sampling region (e.g., by controlling relative motion); and/or,

8. an instruction set that directs the computer to draw one or more selected volumes into the microfluidic device from at least one recirculation/replenishing bath or trough disposed in the container sampling region.

Furthermore, either or both of the controller system and/or the detection system is/are optionally coupled to an appropriately programmed processor or computer which functions to instruct the operation of these instruments in accordance with preprogrammed or user input instructions, receive data and information from these instruments, and interpret, manipulate and report this information to the user. As such, the computer is typically appropriately coupled to one or both of these instruments (e.g., including an analog to digital or digital to analog converter as needed).

The computer also typically includes appropriate software for receiving user instructions, either in the form of user input into a set parameter fields, e.g., in a GUI, or in the form of preprogrammed instructions, e.g., preprogrammed for a variety of different specific operations. The software then converts these instructions to appropriate language for instructing the operation of the fluid direction and transport controller to carry out the desired operation, e.g., varying or selecting the rate or mode of fluid and/or microfluidic device movement, controlling flow rates within microscale channels, directing X-Y-Z translation of the microfluidic device or of one or more microwell plates, or the like. The computer then receives the data from the one or more sensors/detectors included within the system, and interprets the data, either provides it in a user understood format, or uses that data to initiate further controller instructions, in accordance with the programming, e.g., such as in monitoring and control of flow rates, temperatures, applied voltages, and the like. Additionally, the software is optionally used to control pressure or electrokinetic modulated injection or withdrawal of material.

### EXAMPLES

As indicated above, fluid carryover can be reduced, e.g., by washing or rinsing microfluidic device capillary elements to actively remove carried-over fluid materials, such as reagents, samples, or the like. The effectiveness of these approaches is illustrated in the examples, as follows:

### Example 1

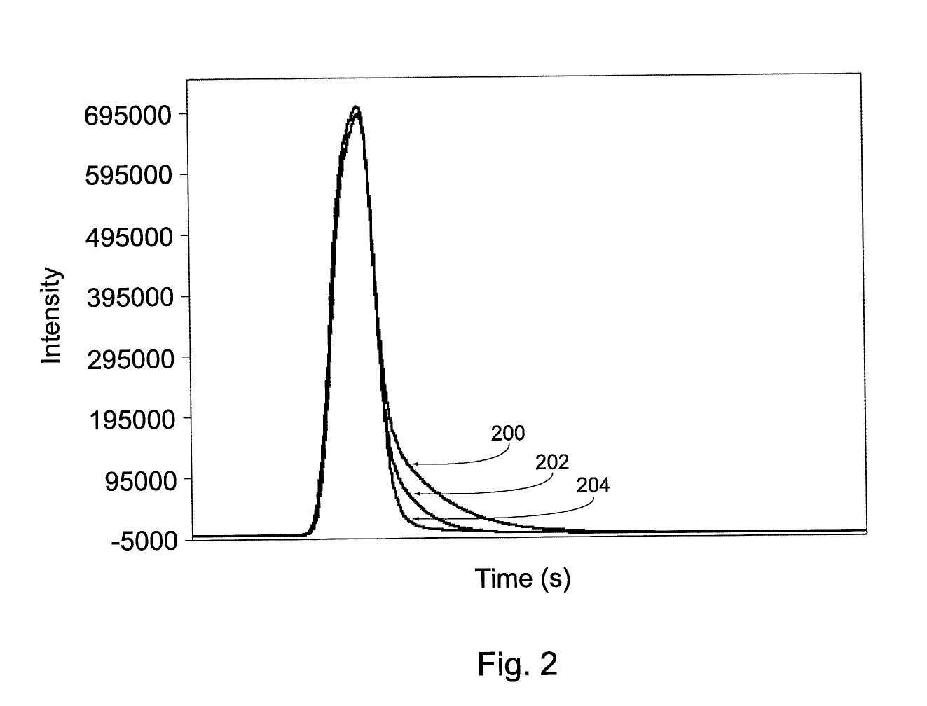

FIG. 2 is a data graph that shows the results of an experiment in which a polyimide-coated capillary element was initially dipped into a well containing a buffer, then dipped into a well filled with a fluorescein dye, and subsequently dipped back into the same buffer-containing well. Upon returning to the buffer well, the capillary element was alternatively not moved in the buffer (shown by histogram 200), moved slowly in a straight line in the buffer (shown by histogram 202), or moved quickly in a semi-circular or arched line of motion in the buffer solution (shown by histogram 204). The y-axis of the graph provides a measure of fluorescent intensity, while the x-axis represents time in seconds (s). As shown, the more rapidly the capillary element moves in the buffer well, which is a measure of how vigorously the capillary element is “washed” or “rinsed,” the more dramatically the tailing of the dye injection peak is reduced, that is, the closer the curve is to a Gaussian or normal error curve.

### Example 2

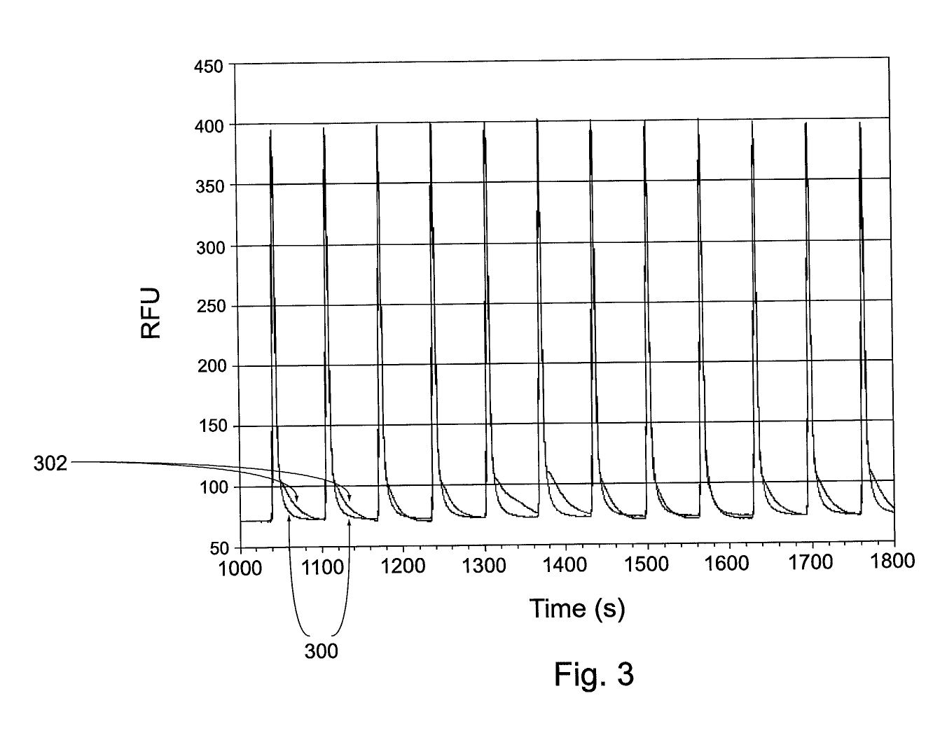

FIG. 3 is a data graph showing the results of an experiment that compared 5 μM 7-amino-4-methylcoumarin (AMC) dye peaks in cathepsin K buffer with and without buffer motion in a recirculation/replenishing trough. The experiment compared the tailing effects when the trough recirculation/replenishing pump was alternately turned on (shown by histogram 300) and off (shown by histogram 302). The y-axis of the graph provides a measure of fluorescent intensity in relative fluorescence units (rfu), while the x-axis represents time in seconds (s). The reduced tailing when the pump was turned on (shown by histogram 300) relative to when the pump was off (shown by histogram 302), indicates that the recirculating buffer also washes the capillary element. Additionally, when the pump was turned on, the recorded peaks were more reproducible, than when the pump was turned off. This result was due to the unpredictability of random convection in the non-recirculating trough.

### Example 3

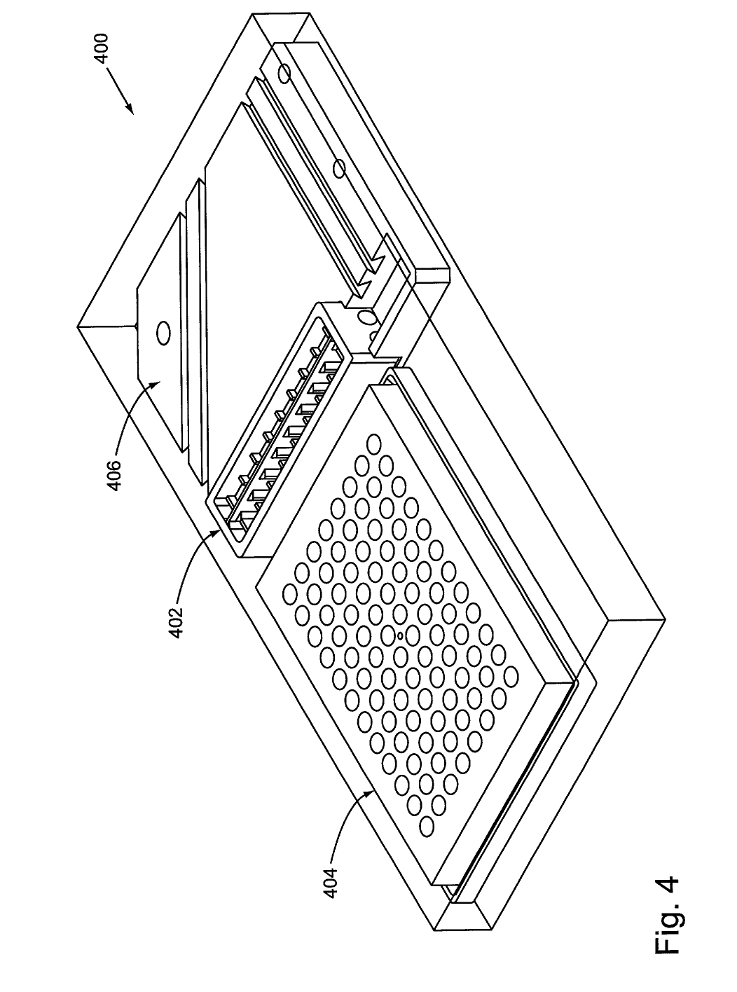

FIG. 4 schematically illustrates the assembly of certain component parts for one embodiment of a container sampling region which is optionally used, e.g., in high-throughput screening as one part of a microfluidic device handling system. These systems are described in greater detail above. As shown, sampling region 400 includes fluid trough 402 (e.g., designed to optimize flow requirements of specific experiments), microwell plate 404, and pump/trough interface region or “shoe” 406. Fluidic materials (e.g., buffers, dyes, or the like) are optionally contained and recirculated or replenished in fluid trough 402. This generally enhances throughput, because these types of fluidic materials are not carried on microwell plate 404, thus leaving additional wells open for more samples. The device depicted in FIG. 4 is designed to accommodate either 96 well or 384 well microwell plates. As mentioned, flow rates and turbulence of fluidic materials in fluid trough 402 are also optionally varied to reduce fluid carryover, e.g., between sampling steps. Optionally, fluid trough 402, itself, is moved relative to a particular microfluidic device while dipped into the trough to minimize carryover.

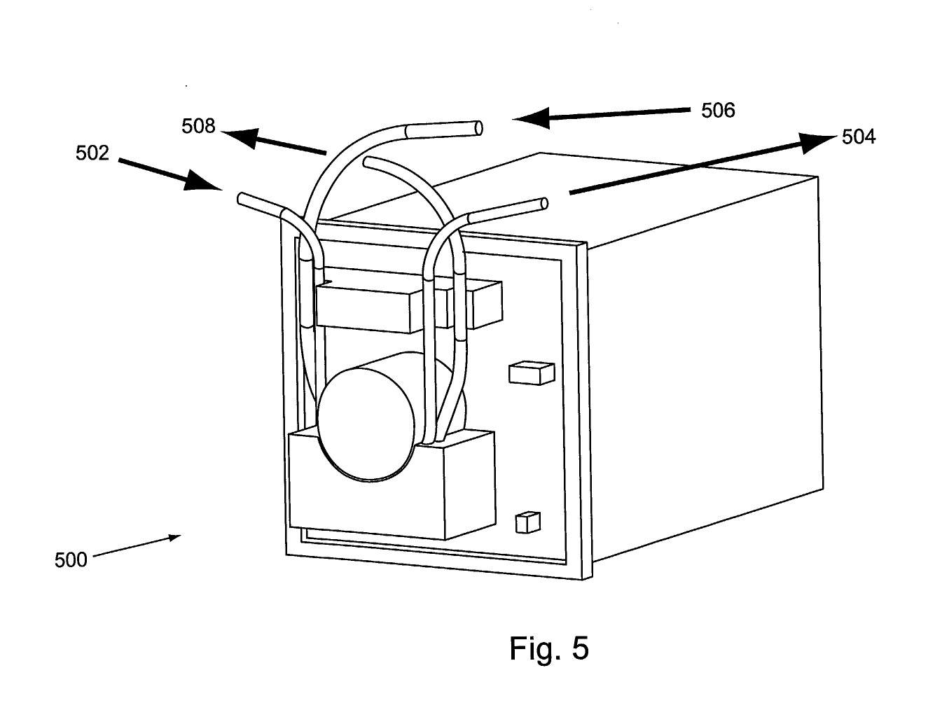

Fluid trough 402 is designed to resist splashing during the motion of microwell plate 404, e.g., when it is replaced with another sample plate. As shown in this embodiment, fluid trough 402 includes two banks, each of which is fluidly connected to a separate pump, such as the one schematically illustrated in FIG. 5. Each bank of fluid trough 402 includes eight compartments that are connected in parallel to each other by a low wall and are bottom fed by, e.g., peristaltic pump 500 through a series of holes. As fluid flows into each bank it cascades over outside walls of the bank within fluid trough 402 and is pumped out using the same pump. The banks depicted in FIG. 4 have total volumes of about 2.18 ml excluding the overflow volume around the perimeter of fluid trough 402.

As mentioned, FIG. 5 schematically shows peristaltic pump 500 and a tube routing configuration for use in the methods and devices described herein. As depicted, fluidic material is drawn from a supply source (e.g., a 500 ml, 1000 ml, or larger fluid container available from many different commercial suppliers, e.g., Nalgene®) through supply inlet line 502 and directed through the same tube through trough inlet line 504 into, e.g., fluid trough 402. Thereafter, the fluidic material is withdrawn from a container, such as fluid trough 402 through trough outlet line 506 and directed through the same line by peristaltic pump 500 to a drain via drain line 508. In preferred embodiments, as described above, the inlet line has a smaller inner diameter (e.g., 0.89 mm) than the outlet line (e.g., 1.14 mm) to ensure that, for any selected RPM, the pump out rate will be greater than the incoming rate to eliminate the chance for fluid overflow from the trough. It should be noted that although FIG. 5 shows a tubing configuration that is used to replenish the fluidic materials, other tubing arrangements are also optionally used, such as a recirculation configuration in which a single tube is directed to and from the fluid container. Suitable pumps for use with this system are available from various commercial suppliers, such as Cole-Parmer Instrument Company (e.g., Masterflex C/L® Tubing Pumps). One such pump used by the inventors included a maximum rate of about 60 RPM which translates into a feed rate of about 2.2 ml/min., but was designed to operate at about 30 RPM (i.e., 1.1 ml/min.).

### Example 4

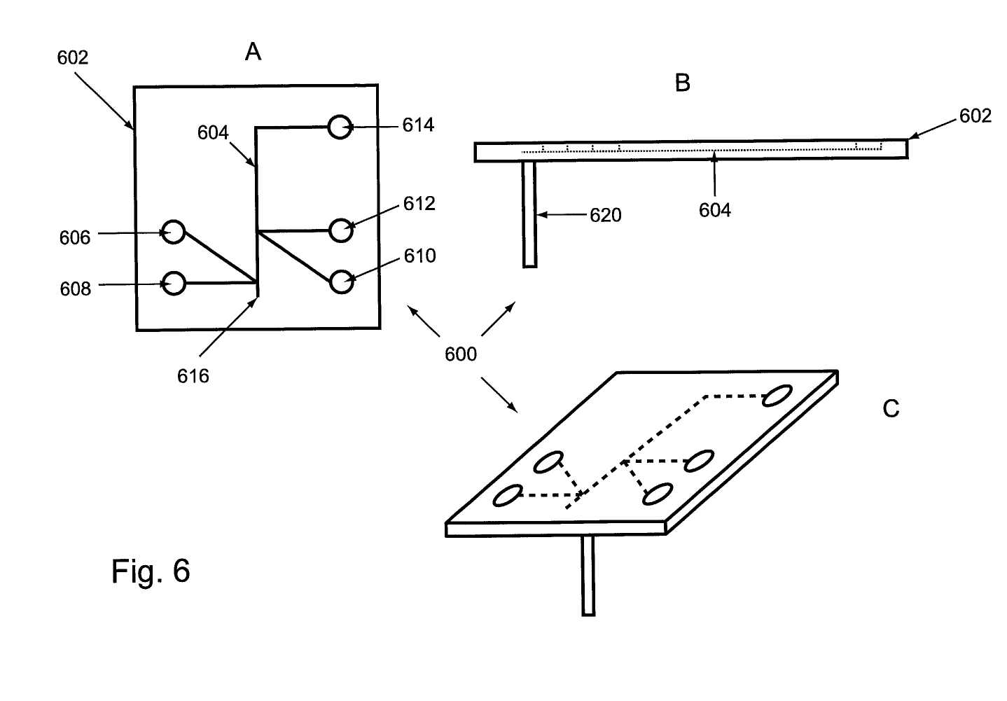

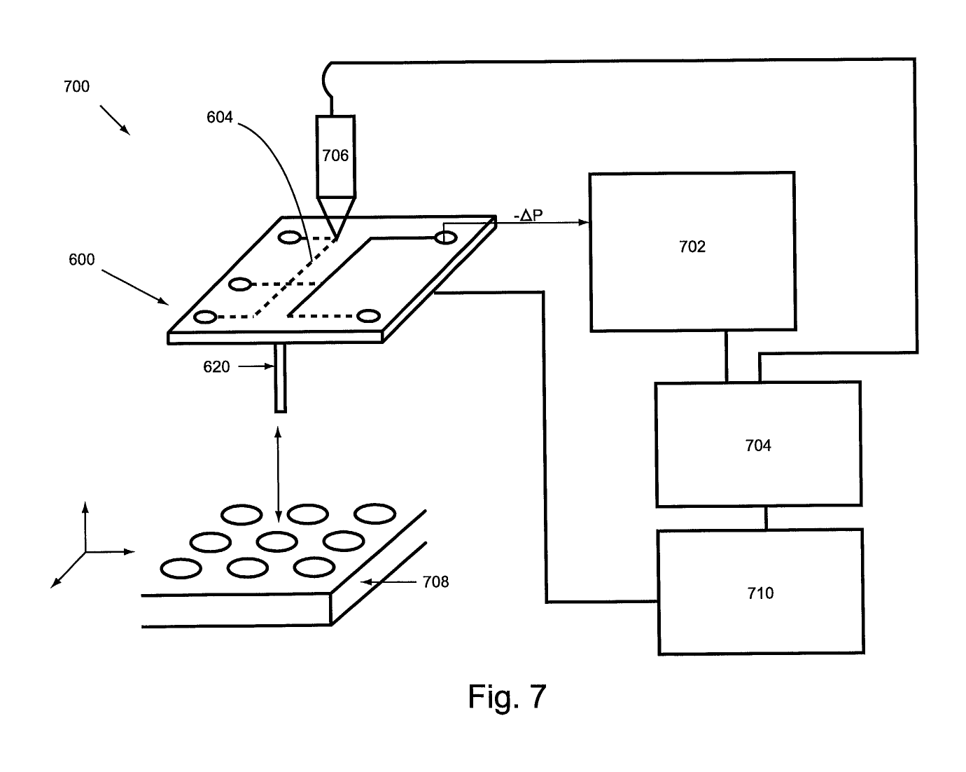

FIG. 6, Panels A, B, and C and FIG. 7 provide additional details regarding example integrated systems that are optionally used to practice the methods herein. As shown, body structure 602 of microfluidic device 600 has main microchannel 604 disposed therein. Cells, reagents, dyes, and/or other materials are optionally flowed from pipettor or capillary element 620 towards reservoir 614, e.g., by applying a vacuum at reservoir 614 (or another point in the system) and/or by applying appropriate voltage gradients. Alternatively, a vacuum is applied at reservoirs 608, 612 or through pipettor or capillary element 620. Additional materials are optionally flowed from wells 608 or 612 and into main microchannel 604. Flow from these wells is optionally performed by modulating fluid pressure, or by electrokinetic approaches as described (or both). As fluid is added to main microchannel 604, e.g., from reservoir 608, the flow rate increases. The flow rate is optionally reduced by flowing a portion of the fluid from main nmicrochannel 604 into flow reduction microchannel 606 or 610. The arrangement of channels depicted in FIG. 6 is only one possible arrangement out of many which are appropriate and available for use in the present invention. Additional alternatives can be devised, e.g., by combining the microfluidic elements described herein with other microfluidic device components described in the patents and applications referenced herein.

Samples or other materials are optionally flowed from the enumerated wells and/or from a source external to the body structure. As depicted, the integrated system typically includes pipettor or capillary element 620, e.g., protruding from body 602, for accessing a source of materials external to the microfluidic system. Typically, the external source is a microtiter dish, a substrate, a membrane, or other convenient storage medium. For example, as depicted in FIG. 7, pipettor or capillary element 620 can access microwell plate 708, which includes sample materials, dyes, buffers, substrate solutions, enzyme solutions, or the like, in the wells of the plate. According to the methods, devices, and systems described herein a recirculation/replenishing bath or trough and a recirculation/replenishing pump (see, e.g., FIGS. 5 and 6, respectively) are also typically included, e.g., to reduce fluid carryover, as described herein.

Detector 706 is in sensory communication with main microchannel 604, detecting signals resulting, e.g., from labeled materials flowing through the detection region. Detector 706 is optionally coupled to any of the channels or regions of the device where detection is desired. Detector 706 is operably linked to computer 704, which digitizes, stores, and manipulates signal information detected by detector 706, e.g., using any logic instruction, e.g., for measuring laser illumination spot widths, for measuring cavity dimensions, for determining concentration, molecular weight or identity, or the like.

Fluid direction system 702 controls pressure, voltage, or both, e.g., at the wells of the system or through the channels or other cavities of the system, or at vacuum couplings fluidly coupled to main microchannel 604 or other channels described above. Optionally, as depicted, computer 704 controls fluid direction system 702. In one set of embodiments, computer 704 uses signal information to select further parameters for the microfluidic system. For example, upon detecting the presence of a component of interest (e.g., following separation) in a sample from microwell plate 708, the computer optionally directs addition of a potential modulator of the component of interest into the system. In certain embodiments, controller 710 dispenses aliquots of selected material into, e.g., main microchannel 604. In these embodiments, controller 710 is also typically operably connected to computer 704, which directs controller 710 function.

Although not shown in this schematic depiction, a microfluidic device handler (described above) is also generally included in the integrated systems of the present invention. Microfluidic device handlers generally control, e.g., the X-Y-Z translation of microfluidic device 600 relative to microwell plate 708 and/or a recirculation/replenishing bath or trough (not shown), of microwell plate 708 and/or a recirculation/replenishing bath or trough (not shown) relative to microfluidic device 600, or of other system components, under the direction of computer 704, e.g., according to appropriate program instructions, to which device handlers are typically operably connected.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications and patent documents cited in this application are incorporated by reference in their entirety for all purposes to the same extent as if each individual publication or patent document were individually so denoted.

What is claimed is:

1. A method of sampling fluid material with a capillary element, the method comprising:
dipping the capillary element into a first fluid material;
dipping the capillary element into a second fluid material; and,
moving the second fluid material relative to the capillary element or moving the capillary element relative to the second fluid material.

2. The method of claim 1, the moving step further comprising moving both the capillary element and the second fluid material simultaneously relative to one another.

3. The method of claim 1, further comprising moving the first fluid material relative to the capillary element, moving the capillary element relative to the first fluid material, or moving both the capillary element and the first fluid material simultaneously relative to one another between the dipping steps.

4. The method of claim 1, further comprising dipping the capillary element into a third fluid material, wherein the moving step dissipates at least one drop of the first fluid material adhering to at least one portion of the capillary element into the second fluid material, thereby reducing fluid carryover from the first dipping step to the third dipping step.

5. The method of claim 1, comprising moving the second fluid material or the capillary element in a lateral motion, a side-to-side motion, a circular motion, a semi-circular motion, a helical motion, an arched motion, or an up-and-down motion.

6. The method of claim 1, comprising moving the second fluid material in at least one fluid stream.

7. The method of claim 1, comprising moving the second fluid material in a fluid recirculation/replenishing bath or trough.

8. The method of claim 1, the first dipping step further comprising drawing at least a portion of the first fluid material into the capillary element.

9. The method of claim 1, the second dipping step further comprising drawing at least a portion of the second fluid material into the capillary element.

10. The method of claim 9, wherein the moving step dissipates carried-over first fluid material in the second fluid material thereby reducing an amount of the carried-over first fluid material drawn into the capillary element.

11. The method of claim 1, wherein the first fluid material comprises a sample or a reagent material.

12. The method of claim 1, wherein the second fluid material comprises at least one solution selected from the group consisting of: a wash solution, a rinse solution, a buffer solution, a reagent solution, a sample solution, a spacer solution, a hydrophobic solution, and a hydrophilic solution.

13. The method of claim 1, comprising providing a capillary channel through the capillary element.

14. The method of claim 1, comprising providing the capillary element to extend from a microfluidic device.

15. The method of claim 14, comprising providing the capillary element to fluidly communicate with at least one channel network disposed in the microfluidic device.

16. The method of claim 1, the method further comprising:
dipping the capillary element into a third fluid material, wherein the third fluid material is identical to or different from the first fluid material;
dipping the capillary element into a fourth fluid material, wherein the fourth fluid material is identical to or different from the second fluid material; and,
moving the fourth fluid material relative to the capillary element or moving the capillary element relative to the fourth fluid material.

17. The method of claim 16, the second moving step further comprising moving both the capillary element and the fourth fluid material simultaneously relative to one another.

18. The method of claim 16, further comprising repeating the third and fourth dipping steps and the second moving step at least once, wherein fluid materials of repeated dipping steps are identical to or different from the third and fourth fluid materials.

19. The method of claim 16, the third dipping step further comprising drawing at least a portion of the third fluid material into the capillary element.

20. The method of claim 16, the fourth dipping step further comprising drawing at least a portion of the fourth fluid material into the capillary element.

21. The method of claim 20, wherein the second and fourth fluid materials are identical, wherein the second moving step dissipates carried-over fluid material in the fourth fluid material thereby reducing an amount of the carried-over fluid material drawn into the capillary element.

22. The method of claim 1, comprising providing a coating on the capillary element.

23. The method of claim 22, wherein the coating reduces fluid carryover.

24. The method of claim 22, comprising coating an interior surface portion, an exterior surface portion, a rim portion, or a combination thereof with the coating.

25. The method of claim 22, the coating comprising a hydrophobic coating or a hydrophilic coating.

26. The method of claim 25, comprising providing the hydrophobic coating to comprise a substance selected from: hydrophobic polymers, fluorocarbon polymers, chlorinated polysiloxanes, polytetrafluoroethylenes, polyglycines, polyalanines, polyvalines, polyleucines, polyisoleucines, chlorine terminated polydimethylsiloxane telomers, bis(perfluorododecyl) terminated poly(dimethylsiloxane-co-dimer acids), and derivatives thereof.

27. The method of claim 25, comprising providing the hydrophilic coating to comprise a substance selected from: hydrophilic polymers, polyethylene oxides, polyvinylpyrrolidone, polyacrylates, hydrophilic polysaccharides, hyaluronic acids, chondroitin sulfates, and derivatives thereof.

28. The method of claim 22, comprising providing the coating to comprise a hydrophobic coating and the second fluid material to comprise a hydrophilic solution.

29. The method of claim 22, comprising providing the coating to comprise a hydrophilic coating and the second fluid material to comprise a hydrophobic solution.

30. A microfluidic device handler comprising:
a holder configured to receive the microfluidic device;
a container sampling region proximal to the holder; and,
a controller operably connected to one or more handler components, which, during operation of the handler, directs dipping of at least a portion of the microfluidic device into at least a portion of at least one container in the container sampling region, the container portion comprising a fluid material, wherein the controller directs movement of the fluid material relative to the microfluidic device, or lateral movement of the microfluidic device in the fluid material while the microfluidic device portion is dipped into the fluid material.

31. The microfluidic device handler of claim 30, wherein the at least one container comprises at least one microwell plate.

32. The microfluidic device handler of claim 30, wherein the at least one container comprises at least one fluid recirculation/replenishing bath or trough, the microfluidic device handler further comprising at least one recirculation/replenishing pump operably connected to the at least one fluid recirculation/replenishing bath or trough.

33. The microfluidic device handler of claim 32, wherein the at least one recirculation/replenishing pump is operably connected to the at least one fluid recirculation/replenishing bath or trough by at least one inlet tube and at least one outlet tube.

34. The microfluidic device handler of claim 33, wherein an inner diameter of the at least one outlet tube is greater than an inner diameter of the at least one inlet tube.

35. The microfluidic device handler of claim 32, wherein the at least one fluid recirculation/replenishing bath or trough comprises a plurality of compartments.

36. The microfluidic device handler of claim 35, wherein each of the plurality of compartments fluidly communicates with at least one other compartment.

37. The microfluidic device handler of claim 35, wherein a bottom portion of at least one of the plurality of compartments comprises at least one fluid inlet.

38. The microfluidic device handler of claim 30, wherein the microfluidic device comprises a capillary element.

39. The microfluidic device handler of claim 38, wherein the capillary element comprises a capillary channel disposed therethrough.

40. The microfluidic device handler of claim 38, wherein the capillary element comprises the portion of the microfluidic device dipped into the fluid material.

41. The microfluidic device handler of claim 38, wherein the capillary element comprises a hydrophobic or a hydrophilic coating disposed on an interior surface portion, an exterior surface portion, a rim portion, or a combination thereof.

42. The microfluidic device handler of claim 30, further comprising a computer or a computer readable medium operably connected to the controller, the computer or the computer readable medium comprising at least one computer program having one or more of:
at least one instruction set that directs the computer to vary or select a rate or a mode of dipping the capillary element into the fluid material;
at least one instruction set that directs the computer to vary or select a rate or a mode with which the fluid material moves relative to the microfluidic device;
at least one instruction set that directs the computer to move the microfluidic device to selected wells of one or more microwell plates disposed in the container sampling region;
at least one instruction set that directs the computer to dip the microfluidic device into selected wells of one or more microwell plates disposed in the container sampling region;
at least one instruction set that directs the computer to draw selected volumes from selected wells of one or more microwell plates disposed in the container sampling region;
at least one instruction set that directs the computer to move the microfluidic device to at least one recirculation/replenishing bath or trough disposed in the container sampling region;
at least one instruction set that directs the computer to dip the microfluidic device into at least one recirculation/replenishing bath or trough disposed in the container sampling region; or,
at least one instruction set that directs the computer to draw one or more selected volumes into the microfluidic device from at least one recirculation/replenishing bath or trough disposed in the container sampling region.

43. The microfluidic device handler of claim 42, wherein the mode of dipping the capillary element comprises one or more movement relative to the fluid material comprising a lateral motion, a side-to-side motion, a circular motion, a semicircular motion, a helical motion, an arched motion, or an up-and-down motion.

44. The microfluidic device handler of claim 42, wherein the mode with which the fluid material moves comprises one or more of: a fluid stream, a lateral motion, a side-to-side motion, a circular motion, a semi-circular motion, a helical motion, or an arched motion.
